(19) United States
(12) Patent Application Publication
(10) Pub. No.: US 2025/0048359 A1
(43) Pub. Date: Feb. 6, 2025

(54) SIMULTANEOUS UPLINK TRANSMISSION SCHEMES IN WIRELESS COMMUNICATIONS

(71) Applicant: ZTE Corporation, Shenzhen (CN)

(72) Inventors: Yang ZHANG, Shenzhen (CN); Bo GAO, Shenzhen (CN); Xiaolong GUO, Shenzhen (CN); Ke YAO, Shenzhen (CN); Zhaohua LU, Shenzhen (CN); Wenjun YAN, Shenzhen (CN)

(21) Appl. No.: 18/920,688

(22) Filed: Oct. 18, 2024

Related U.S. Application Data
(63) Continuation of application No. PCT/CN2022/088053, filed on Apr. 21, 2022.

(51) Int. Cl. H04W 72/1268; H04W 72/0446; H04W 76/15

(52) U.S. Cl. CPC H04W 72/1268; H04W 72/0446; H04W 76/15

(57) ABSTRACT

A method of wireless communication is described. The wireless communication method includes making a determination, by a user device, whether a predetermined condition is met; and performing, in response to the determination that the predetermined condition is met, a subsequent operation that is a simultaneous uplink channel transmission that transmits a first uplink signal and a second uplink signal which are partially or fully overlapped in time domain.

### CROSS-REFERENCE TO RELATED APPLICATIONS

This application is a continuation of International Patent Application No. PCT/CN2022/088053, filed on Apr. 21, 2022, the contents of which are incorporated herein by reference in their entirety.

### TECHNICAL FIELD

This patent document generally relates to systems, devices, and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices.

### SUMMARY

This document relates to methods, systems, and devices for simultaneous uplink transmission schemes in wireless communications.

In one aspect, a wireless communication method is disclosed. The wireless communication method includes making a determination, by a user device, whether a predetermined condition is met; and performing, in response to the determination that the predetermined condition is met, a subsequent operation that is a simultaneous uplink channel transmission that transmits a first uplink signal and a second uplink signal which are partially or fully overlapped in time domain.

In another aspect, a wireless communication method is disclosed. The wireless communication method includes transmitting, by a network device to a user device, an indication to perform a simultaneous uplink channel transmission; and receiving a first uplink signal and a second uplink signal at least partially overlapping with the first uplink signal in time domain.

In another aspect, a communication apparatus comprising a processor configured to implement the above-described method is disclosed.

In another aspect, a computer readable medium having code stored thereon, the code, when executed, causing a processor to implement the above-described method is disclosed.

These, and other features, are described in the present document.

### BRIEF DESCRIPTION OF THE DRAWING

FIG. 1 shows a single DCI (downlink control information) based MTRP (multiple transmission and reception point) uplink reception via SFN (single frequency network) scheme based on some implementations of the disclosed technology.

FIG. 2 shows a single DCI based MTRP uplink transmission via SDM (spatial division multiplexing) scheme based on some implementations of the disclosed technology.

FIG. 3 shows a single DCI based MTRP uplink transmission with different CWs (codewords) via SDM (spatial division multiplexing) scheme based on some implementations of the disclosed technology.

FIG. 4 shows a single DCI based MTRP uplink repetition via FDM (frequency division multiplexing) scheme A based on some implementations of the disclosed technology.

FIG. 5 shows a single DCI based MTRP uplink transmission via FDM (frequency division multiplexing) scheme B based on some implementations of the disclosed technology.

FIG. 6 shows a multi-DCI based MTRP uplink repetition based on some implementations of the disclosed technology.

FIG. 7 shows a multi-DCI based MTRP uplink repetition based on some implementations of the disclosed technology.

FIG. 8 shows a simultaneous uplink transmission in CA (carrier aggregation) operation based on some implementations of the disclosed technology.

FIG. 9 shows a simultaneous uplink transmission in SUL (supplementary uplink) operation based on some implementations of the disclosed technology.

FIGS. 10 and 11 illustrate flowcharts showing example methods of wireless communication based on some implementations of the disclosed technology.

FIG. 12 shows an example of wireless communication including a base station (BS) and user equipment (UE) based on some implementations of the disclosed technology.

FIG. 13 shows an example of a block diagram of a portion of an apparatus based on some implementations of the disclosed technology.

### DETAILED DESCRIPTION

The disclosed technology provides implementations and examples of simultaneous uplink transmission schemes in wireless communications.

In current 5G NR system, due to the limitations on the UE capability, uplink transmission can only be performed in a non-overlapping manner in time domain, which would be a bottleneck for the throughput of the whole system once multi-TRP based downlink transmission can be supported. Accordingly, some restrictions of uplink transmission are specified to guarantee the capability of the single panel UE, such as the dropping rules of uplink control information (UCI) multiplexing, the omitting of channel state information (CSI) reporting, CSI piggyback on PUSCH, etc. Meanwhile, with the evolution of the mobile communication technology, the UE can be equipped with multiple panels to implement uplink simultaneous transmission for higher throughput in the future.

The simultaneous uplink transmissions in multiple transmission and reception point (MTRP) operation can improve the throughput of the uplink data transmission. Various implementations of the disclosed technology provide some approach and details to support such enhancements by the simultaneous uplink scheme for both UE side and gNB side.

The 5G NR includes a number of MIMO features that facilitate utilization of a large number of antenna elements at a base station for both sub-6GHz (Frequency Range 1, FR1) and over-6GHz (Frequency Range 2, FR2) frequency bands, plus one of the MIMO features is that it supports for multi-TRP operation. The key point of this functionality is to collaborate with multiple TRPs to transmit or receive data to and from the UE to improve transmission performance. As NR is in the process of commercialization, various aspects that require further enhancements can be identified from real deployment scenarios. According to the current evolution for 5G NR in 3GPP, simultaneous uplink transmissions can be supported and performed by multi-panel UE in MTRP operation, which is beneficial to improve the throughput of uplink transmission.

Notes that, in this patent document, “simultaneous uplink transmission scheme” refers to multiple uplink transmissions that can be fully or partially overlapping in time domain. The simultaneous uplink transmissions can be associated with different panels/TRP IDs. The simultaneous uplink transmission scheme includes at least one of following scenarios.

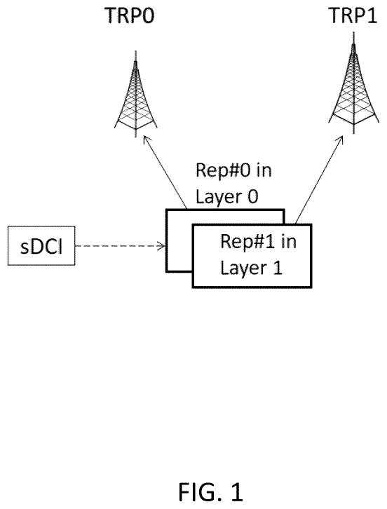

FIG. 1 shows a single DCI based MTRP uplink reception via SFN (single frequency network) scheme based on some implementations of the disclosed technology. In FIG. 1, two repetitions of one same TB/CW (codeword) of PUSCH/PUCCH (e.g., Rep #0 in Layer 0 and Rep #1 in Layer 1) are scheduled by one single DCI (sDCI) to be transmitted on same time-frequency domain resource but different transmission layers with different beams. These two uplink repetitions are transmitted from multiple panels (e.g. 2 panels) and towards multiple TRPs (e.g., TRP0 and TRP1).

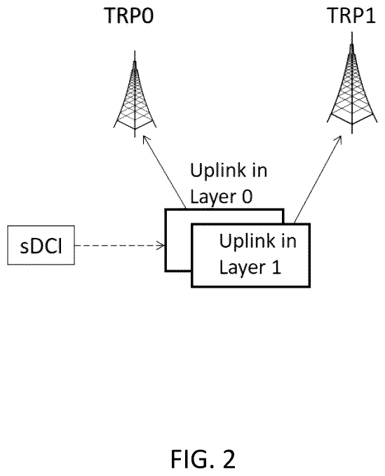

FIG. 2 shows a single DCI based MTRP uplink transmission via SDM (spatial division multiplexing) scheme based on some implementations of the disclosed technology. In FIG. 2, two transmission occasions of one TB/CW of PUSCH/PUCCH (e.g., Uplink in Layer 0 and Uplink in Layer 1) are scheduled by one single DCI (sDCI) to be transmitted on same time-frequency domain resource but different transmission layers with different beams. These two uplink repetitions are transmitted from multiple panels (e.g. 2 panels) and towards multiple TRPs (e.g., TRP0 and TRP1).

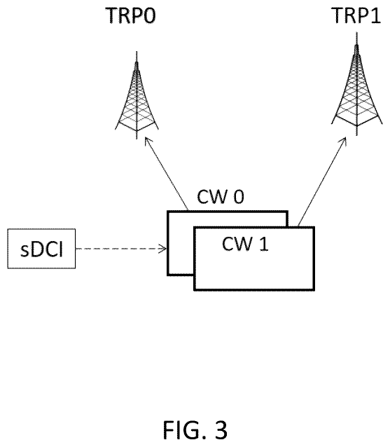

FIG. 3 shows a single DCI based MTRP uplink transmission with different CWs (codewords) via SDM (spatial division multiplexing) scheme based on some implementations of the disclosed technology. In FIG. 3, two transmission occasions of two TB/CW of PUSCH/PUCCH (CW0 and CW1) are scheduled by one single DCI (sDCI) to be transmitted on same time-frequency domain resource but different transmission layers with different beams. The two uplink repetitions are transmitted from multiple panels (e.g. 2 panels) and towards multiple TRPs (e.g., TRP0 and TRP1).

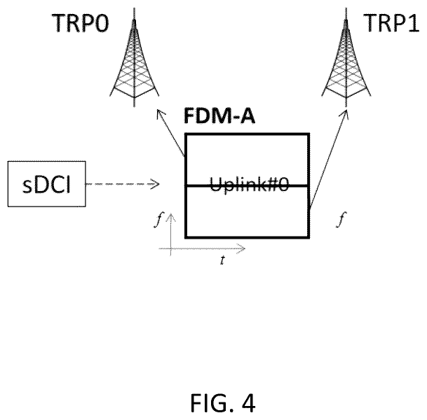

FIG. 4 shows a single DCI based MTRP uplink transmission via FDM (frequency division multiplexing) scheme A. In FIG. 4, two transmission occasions of one TB/CW of PUSCH/PUSCH (e.g., two portions of Uplink#0) are scheduled by one single DCI (sDCI) to be transmitted on same time domain resource but different frequency domain resources with different beams. The two uplink transmission occasions are transmitted from multiple panels (e.g. 2 panels) and towards multiple TRPs (e.g., TRP0 and TRP1).

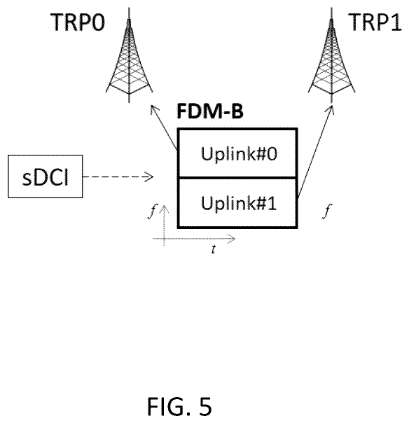

FIG. 5 shows a single DCI based MTRP uplink repetition via FDM (frequency division multiplexing) scheme B. In FIG. 5, two repetitions of one same TB/CW of PUSCH/PUSCH (e.g., Uplink #0 and Uplink #1) are scheduled by one single DCI (sDCI) to be transmitted on same time domain resource but different frequency domain resources with different beams. The two uplink repetitions are transmitted from multiple panels (e.g. 2 panels) and towards multiple TRPs (e.g., TRP0 and TRP1).

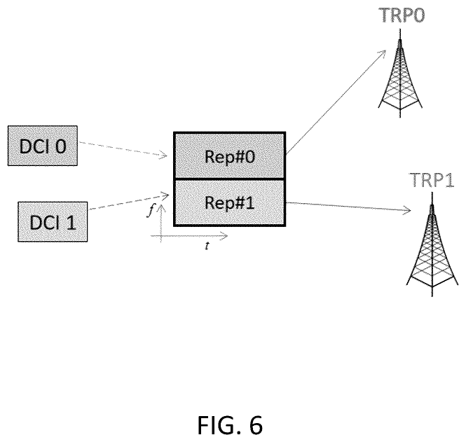

FIG. 6 shows a multi-DCI based MTRP uplink repetition. In FIG. 6, two repetitions of one same TB/CW of PUSCH/PUCCH (Rep #0 and Rep #1) are scheduled by two different DCIs (DCI0 and DCI1), respectively, to be transmitted in full or partial overlapping in time domain with different beams. The two uplink repetitions are transmitted from multiple panels (e.g. 2 panels) and towards multiple TRPs (e.g., TRP0 and TRP1).

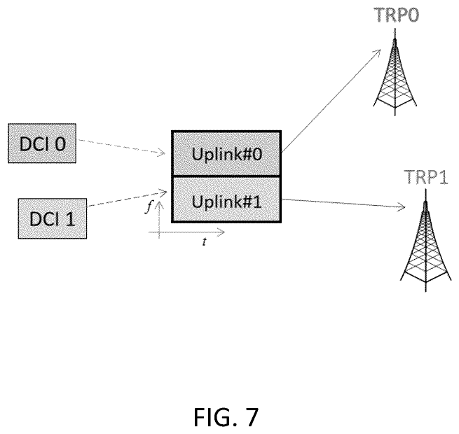

FIG. 7 shows a multi-DCI based MTRP uplink repetition. In FIG. 7, two transmission occasions of two TB/CWs of PUSCH/PUCCH (Uplink #0 and Uplink #1) are scheduled by two different DCIs (DCI0 and DCI1), respectively, to be transmitted in full or partial overlapping in time domain with different beams. The two uplink transmissions are transmitted from multiple panels (e.g. 2 panels) and towards multiple TRPs (e.g., TRP0 and TRP1).

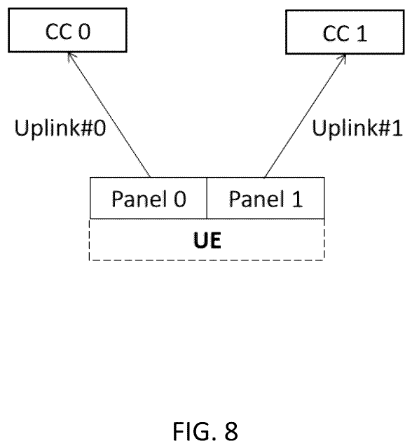

FIG. 8 shows a simultaneous uplink transmission in CA operation. In FIG. 8, the two PUSCHs/PUCCHs are scheduled by one or two DCIs and to be transmitted in full or partial overlapping in time domain with different beams. The two uplink transmissions are transmitted from multiple panels (e.g. 2 panels) and in two different CCs (CC0 and CC1).

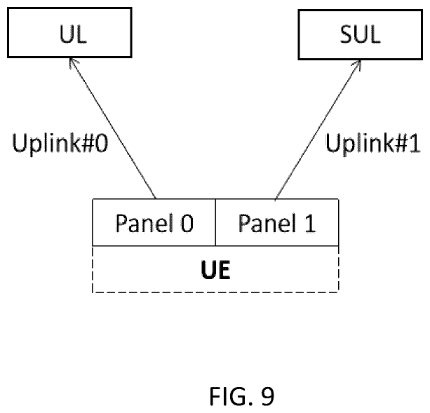

FIG. 9 shows a simultaneous uplink transmission in SUL operation. In FIG. 9, the two transmission occasions of two TBs/CWs of PUSCH/PUCCH are scheduled by two different DCIs, respectively, to be transmitted in full or partial overlapping in time domain with different beams. The two uplink transmissions are transmitted from multiple panels (e.g. 2 panels) and in two different ULs (UL and SUL).

In some implementations of the disclosed technology, whether the UE supports the “simultaneous uplink transmission scheme” can be reported as the UE's optional capability.

In some implementations of the disclosed technology, “beam state” refers to at least one of quasi-co-location (QCL) state, transmission configuration indicator (TCI) state, spatial relation (also called as spatial relation information), reference signal (RS), spatial filter or precoding. In some implementations, “beam state” is also called as “beam”. In some implementations, “Tx beam” refers to at least one of QCL state, TCI state, spatial relation state, DL reference signal, UL reference signal, Tx spatial filter or Tx precoding. In some implementations, “Rx beam” refers to at least one of QCL state, TCI state, spatial relation state, spatial filter, Rx spatial filter or Rx precoding. In some implementations, “beam ID” refers to at least one of QCL state index, TCI state index, spatial relation state index, reference signal index, spatial filter index or precoding index.

In some implementations of the disclosed technology, the spatial filter can be either UE-side or gNB-side one, and the spatial filter is also called as spatial-domain filter. In some implementations, “spatial relation information” includes one or more reference RSs, which is used to represent the same or quasi-co “spatial relation” between targeted “RS or channel” and the one or more reference RSs.

In some implementations, “spatial relation” refers to least one of the beam, spatial parameter, or spatial domain filter.

In some implementations, “QCL state” includes one or more reference RSs and their corresponding QCL type parameters, where QCL type parameters include at least one of the following aspect or combination: 1) Doppler spread, 2) Doppler shift, 3) delay spread, 4) average delay, 5) average gain, and 6) spatial parameter (which is also called as spatial Rx parameter). In some implementations, “TCI state” refers to “QCL state.” In some implementations, ‘QCL-TypeA’ refers to {Doppler shift, Doppler spread, average delay, delay spread}, ‘QCL-TypeB’ refers to {Doppler shift, Doppler spread}, ‘QCL-TypeC’ refers to {Doppler shift, average delay}, and ‘QCL-TypeD’ refers to {Spatial Rx parameter}.

In some implementations, a RS comprises channel state information reference signal (CSI-RS), synchronization signal block (SSB) (which is also called as SS/PBCH), demodulation reference signal (DMRS), sounding reference signal (SRS), and physical random access channel (PRACH). Furthermore, the RS at least comprises DL reference signal and UL reference signalling. In some implementations, a DL RS comprises at least CSI-RS, SSB, or DMRS (e.g., DL DMRS). In some implementations, a UL RS comprises at least SRS, DMRS (e.g., UL DMRS), or PRACH.

In some implementations, “UL signal” can be PUCCH, PUSCH, or SRS. In some implementations, “DL signal” can be PDCCH, PDSCH, or CSI-RS.

In some implementations, the indication of TCI state can be used for at least one of DL and UL joint, DL only, or UL only. In some implementations, there can be one or two TCI state indication fields in DCI. In some implementations, the TCI state indication can be used for at least one of a single TRP/panel individually, or multiple TRPs/panels simultaneously.

In some implementations, “component carrier (CC)” refers to serving cell or bandwidth part (BWP) of CC. In some implementations, “CC group” refers to a group including one or more CC(s). The CC group can be configured by a higher layer configuration (e.g., simultaneousTCI-UpdateList-r16, simultaneousTCI-UpdateListSecond-r16). In some implementations, “CORESET” refers to PDCCH or DCI. In some implementations, “CORESET group index” refers to the index of a group including one or more CORESET(s). The CORESET can be configured by a higher layer configuration (e.g., CORESETPoolIndex).

In some implementations, “panel” or “the UE's panel” refers to a physical (or logical) antenna group (or panel) of the UE. In some implementations, “symbol” refers to a orthogonal frequency division multiplexing (OFDM) symbol. In some implementations, “A is associated with B” means that A and B have an direct or indirect relationship. It means that A (or B) can be determined according to B (or A).

### Overview

In some implementations, if at least one of conditions is satisfied, the UE performs simultaneous uplink transmissions from different panels (e.g., two panels) and towards different TRPs/CCs/ULs (e.g., two TRPs/CCs/ULs).

The at least one of the conditions may be satisfied in the following example cases:
A simultaneous uplink transmission scheme is determined to the UE. This indication can be made explicitly or implicitly and correspond to at least one of a RRC, a MAC CE or DCI. The indication will indicate a simultaneous uplink transmission scheme among those as described with reference to FIG. 1 to which is discussed with reference to FIGS. 1 to 9.
A first uplink signal and a second uplink signal are fully or partially overlapped in time domain.
A first information associated with the first uplink signal is different from the first information associated with the second uplink signal. The first information can include at least one of a panel index or TRP index. The first information is used to identify a panel of the UE where the uplink signal is transmitted or a TRP where the uplink signal is received. In some implementations, the TRP index refers to at least one of SRS resource set index, spatial relation index, power control parameter set index, TCI state index, CORESET index, CORESETPoolIndex value, physical cell index (PCI), sub-array index, the index of CDM group of DMRS ports, the group index of CSI-RS resources, or CMR set index. In some implementations, the panel index refers to at least one of UE capability value set index, panel mode index, antenna group index, antenna port group index, beam group index, beam reporting group index, sub-array index, SRS resource set index, or spatial relation index, power control parameter set index, CORESETPoolIndex value, or PCI.
A second information associated with first uplink signal is different from the second information associated with the second uplink signal. The second information can include at least one of a component carrier (CC), a CC group or a group of CORESETs. The second information is used to identify a serving cell or a CC where the uplink signal is transmitted.
A third information associated with first uplink signal is different from the third information associated with the second uplink signal. The third information can include at least one of a UL/SUL indicator in a serving cell (or a CC), a frequency band index, or a uplink BWP index. The third information is used to identify a configured or indicated uplink in a serving cell where the uplink signal is transmitted.

In some implementations, the simultaneous transmission scheme can be indicated by a control signalling explicitly or implicitly, where the control signalling is provided by at least one of a RRC, a MAC CE or a DCI. In some implementations, the time unit of the overlapped part of the first uplink signal and the second uplink signal in time domain can be at least one of sub-symbol, symbol, slot, sub-frame, frame, or transmission occasion.

In some implementations, “the first/second/third information associated with the first uplink signal is different with the first/second/third information associated with the second uplink signal” comprises at least one of the following: 1) the first information (e.g., TRP index or the panel index) that can be indicated by RRC, MAC CE, or DCI explicitly or implicitly, 2) the control information (e.g., DCI) of the first uplink signal that can be the same to or different from the control information of the second uplink signal, 3) the priority of UCI reporting carried on the first uplink signal that is different from the priority of UCI reporting carried on the second uplink signal, 4) the type of UCI reporting carried on the first uplink signal that is different from the type of UCI reporting carried on the second uplink signal, 5) the content (e.g., UCI reporting, control data, user data, transmission block, or codeword) of the first uplink signal that is different from the content of the second uplink signal.

### Implementation 1: Overlapping Between Two Physical Channels for UCI Reporting With Different Priorities

The following cases discuss scenarios of the overlapping two physical channels with different priorities. In each case, depending on whether the simultaneous uplink transmission scheme is provided or not, the corresponding operations are performed. As discussed in the overview above, the simultaneous uplink transmission scheme is provided when at least one of the specific conditions is satisfied.

### Case 1

A UE determines an overlapping of PUCCH and/or PUSCH transmissions of different priority indexes, including repetitions if any, if a transmission of a first PUCCH of larger priority index scheduled by a first DCI format in a first PDCCH reception fully or partially overlaps in time with the repetition(s) of a second PUSCH or a second PUCCH of smaller priority index.

If the simultaneous uplink transmission scheme is not provided, the UE first resolves the overlapping of PUCCH and/or PUSCH transmissions of smaller priority index. In this case, the UE cancels the repetition(s) of the second PUSCH or the second PUCCH before the first symbol overlapping with the first PUCCH transmission.

If the simultaneous uplink transmission scheme is provided, the UE can transmit the first PUCCH of larger priority index scheduled by the first DCI format in the first PDCCH reception and the repetition(s) of a second PUSCH or the second PUCCH of smaller priority index. In this case, the first PUCCH is associated with a first panel/TRP/CC/uplink index, and the repetition(s) of the second PUSCH or the second PUCCH is associated with a second panel/TRP/CC/uplink index.

### Case 2

A UE determines overlapping of PUCCH and/or PUSCH transmissions of different priority indexes, including repetitions if any, if a transmission of a first PUSCH of larger priority index scheduled by a first DCI format in a first PDCCH reception fully or partially overlaps in time with a repetition of the transmission of a second PUCCH of smaller priority index.

If the simultaneous uplink transmission scheme is not provided, the UE cancels the repetition of the transmission of the second PUCCH before the first symbol that would overlap with the first PUSCH transmission.

If the simultaneous uplink transmission scheme is provided, the UE transmits the transmission of the first PUSCH of larger priority index scheduled by a DCI format in a PDCCH reception and a repetition of the transmission of a second PUCCH of smaller priority index. In this case, the first PUSCH is associated with a first panel/TRP/CC/uplink index, and the repetition(s) of the second PUCCH transmission is associated with a second panel/TRP/CC/uplink index.

### Case 3

A UE transmits the certain channels, including repetitions if any, that fully or partially overlap in time. The certain channels include at least one of followings:
a first PUCCH of larger priority index with SR and a second PUCCH or PUSCH of smaller priority index
a first PUCCH of larger priority index with HARQ-ACK information only in response to PDSCH(s) reception without corresponding PDCCH(s) and a second PUCCH of smaller priority index with HARQ-ACK information only in response to PDSCH(s) reception without corresponding PDCCH(s), or a second PUCCH of smaller priority index with SR and/or CSI, or a configured grant PUSCH with smaller priority index, or a PUSCH of smaller priority index with SP-CSI report(s) without a corresponding PDCCH
a PUSCH of larger priority index with SP-CSI reports(s) without a corresponding PDCCH and a PUCCH of smaller priority index with SR, or CSI, or HARQ-ACK information only in response to PDSCH(s) reception without corresponding PDCCH(s)
a configured grant PUSCH of larger priority index and a configured PUSCH of smaller priority index on a same serving cell

When the UE transmits at least one of the above channels, following operations are performed depending on whether the simultaneous uplink transmission scheme is provided or not.

If the simultaneous uplink transmission scheme is not provided, the UE is expected to cancel a repetition of the PUCCH/PUSCH transmissions of smaller priority index before the first symbol overlapping with the PUCCH/PUSCH transmission of larger priority index if the repetition of the PUCCH/PUSCH transmissions of smaller priority index overlaps in time with the PUCCH/PUSCH transmissions of larger priority index.

If the simultaneous uplink transmission scheme is provided, the UE transmits the first PUCCH/PUSCH transmission with larger priority index and the repetition of the second PUCCH/PUSCH transmission with smaller priority index. In this case, the first PUCCH/PUSCH transmission is associated with a first panel/TRP/CC/uplink index, and the repetition(s) of the second PUCCH/PUSCH transmission is associated with a second panel/TRP/CC/uplink index.

### Case 4

If the simultaneous uplink transmission scheme is not provided, the UE does not expect to be scheduled to transmit a PUCCH or a PUSCH with smaller priority index that overlaps in time with a PUCCH of larger priority index, the PUCCH with HARQ-ACK information only, in response to a PDSCH reception without a corresponding PDCCH.

If the simultaneous uplink transmission scheme is provided, the UE transmits a first PUCCH with larger priority index with HARQ-ACK information only in response to a PDSCH reception without a corresponding PDCCH and a second PUCCH/PUSCH transmission with smaller priority. In this case, the first PUCCH is associated with a first panel/TRP/CC/uplink index, and the repetition(s) of the second PUCCH/PUSCH is associated with a second panel/TRP/CC/uplink index.

### Case 5

If the simultaneous uplink transmission scheme is not provided, the UE does not expect to be scheduled to transmit a PUCCH of smaller priority index that would overlap in time with a PUSCH of larger priority index with SP-CSI report(s) without a corresponding PDCCH.

If the simultaneous uplink transmission scheme is provided, the UE transmits a first PUSCH of larger priority index with SP-CSI report(s) without a corresponding PDCCH and a second PUCCH of smaller priority index. In this case, the first PUSCH is associated with a first panel/TRP/CC/uplink index, and the repetition(s) of the second PUCCH is associated with a second panel/TRP/CC/uplink index.

### Case 6

A UE is not provided multi-CSI-PUCCH-ResourceList. A resource for a PUCCH transmission with HARQ-ACK information in response to SPS PDSCH reception and/or a resource for a PUCCH associated with a SR occasion overlap in time with two resources for respective PUCCH transmissions with two CSI reports, and there is no resource for a PUCCH transmission with HARQ-ACK information in response to a DCI format detection that overlaps in time with any of the previous resources.

If the simultaneous uplink transmission scheme is not provided, the pseudo code results to the UE attempting to determine a single PUCCH resource from the HARQ-ACK and/or the SR resource and the two PUCCH resources with CSI reports. The UE multiplexes the HARQ-ACK information and/or the SR in the resource for the PUCCH transmission with the CSI report having the higher priority, and does not transmit the PUCCH with the CSI report having the lower priority.

If the simultaneous uplink transmission scheme is provided, the UE transmits the HARQ-ACK information and/or the SR with the CSI report that has the higher priority in the resource for a first PUCCH transmission and the CSI report having the lower priority in another resource for a second PUCCH transmission. The first PUCCH resource is determined by the result of pseudo code from the HARQ-ACK and/or the SR resource and the two PUCCH resources with CSI reports. In this case, the first PUCCH transmission is associated with a first panel/TRP/CC/uplink index, and the second PUCCH transmission is associated with a second panel/TRP/CC/uplink index.

### Case 7

A UE transmits a first PUCCH over more than one slot and at least a second PUCCH over one or more slots, and the transmissions of the first PUCCH and the second PUCCH would overlap in a number of slots then, for each slot of the number of slots and with UCI type priority of HARQ-ACK>SR>CSI with higher priority>CSI with lower priority. Thus, the UCI report with HARQ-ACK has priority over the UCI report with SR, the UCI report with SR has priority over the UCI report with {CSI with higher priority}, and the UCI report with {CSI with higher priority} has priority over UCI report with {CSI with lower priority}.

If the simultaneous uplink transmission scheme is not provided, the UE does not expect the first PUCCH and any of the second PUCCHs to start at a same slot and include a UCI type with same priority. If the first PUCCH and any of the second PUCCHs include a UCI type with same priority, the UE transmits the PUCCH starting at an earlier slot and does not transmit the PUCCH starting at a later slot. If the first PUCCH and any of the second PUCCHs do not include a UCI type with same priority, the UE transmits the PUCCH that includes the UCI type with higher priority and does not transmit the PUCCH that include the UCI type with lower priority.

If the simultaneous uplink transmission scheme is provided, the UE transmits the first PUCCH and any of the second PUCCHs to start at a same slot and include a UCI type with same priority. In this case, the first PUCCH is associated with a first panel/TRP ID, and the second PUCCH is associated with a second panel/TRP/CC/uplink index. If the first PUCCH and any of the second PUCCHs include a UCI type with same priority, the UE transmits the first PUCCH and any of the second PUCCHs regardless of whether which one starts at an earlier slot. In this case, the first PUCCH is associated with a first panel/TRP ID, and the second PUCCH is associated with a second panel/TRP/CC/uplink index. If the first PUCCH and any of the second PUCCHs do not include a UCI type with same priority, the UE transmits the PUCCH that includes the UCI type with higher priority and the PUCCH that include the UCI type with lower priority. In this case, the first PUCCH is associated with a first panel/TRP/CC/uplink index, and the second PUCCH is associated with a second panel/TRP/CC/uplink index.

### Case 8

CSI reports are transmitted on a PUCCH, if any of the CSI reports consist of two parts.

If the simultaneous uplink transmission scheme is not provided, the UE may omit a portion of Part 2 CSI. The omission of Part 2 CSI is according to the priority order determined from the Prii,CSI(y,k,c,s) value. The Part 2 CSI is omitted beginning with the lowest priority level until the Part 2 CSI code rate is less or equal to the one configured by higher layer parameter maxCodeRate.

If the simultaneous uplink transmission scheme is provided, the UE transmits the Part 1 CSI in a first PUCCH and the Part 2 CSI in a second PUCCH. In this case, the first PUCCH is associated with a first panel/TRP/CC/uplink index, and the second PUCCH is associated with a second panel/TRP/CC/uplink index.

### Case 9

A UE is configured to transmit two colliding CSI reports (in time domain), for aperiodic CSI and SP CSI reported on PUSCH.

If the simultaneous uplink transmission scheme is not provided, the CSI report with higher ^{Pri}_{iCSI}^{(y,k,c,s)} value shall not be sent by the UE, or the two CSI reports are multiplexed or either is dropped based on the priority values.

If the simultaneous uplink transmission scheme is provided, the UE transmits the aperiodic CSI report in a first PUSCH and the SP SCI report in a second PUSCH. In this case, the first PUCCH is associated with a first panel/TRP/CC/uplink index, and the second PUCCH is associated with a second panel/TRP/CC/uplink index.

### Implementation 2: Overlapping Between Two Physical Channels for UCI Reporting With Different Types

The following cases discuss scenarios of the overlapping two physical channels for UCI reporting with different types. In each case, depending on whether the simultaneous uplink transmission scheme is provided or not, the corresponding operations are performed.

### Case 1

In some embodiments, the UE needs to multiplex DL HARQ-ACK information, with or without SR, and CSI report(s) in a same PUCCH if the parameter, simultaneous HARQ-ACK-CSI, is not provided to the UE. The parameter, simultaneous HARQ-ACK-CSI enables the simultaneous transmission of CSI and HARQ-ACK feedback with or without SR with PUCCH Format 2, 3 or 4.

If the simultaneous uplink transmission scheme is not provided, the UE drops the CSI report(s) and includes only DL HARQ-ACK information, with or without SR, in the PUCCH.

If the simultaneous uplink transmission scheme is provided, the UE transmits a first PUCCH with DL HARQ-ACK information, with or without SR, and a second PUCCH with the CSI report(s). In this case, the first PUCCH is associated with a first panel/TRP/CC/uplink index, and the second PUCCH is associated with a second panel/TRP/CC/uplink index.

### Case 2

The UE would transmit a PUCCH with positive or negative SR and at most two HARQ-ACK information bits in a resource using PUCCH format 0.

If the simultaneous uplink transmission scheme is not provided, the UE transmits the PUCCH in the resource using PUCCH format 0 for HARQ-ACK information only.

If the simultaneous uplink transmission scheme is provided, the UE transmits a first PUCCH in the resource using PUCCH format 0 for HARA-ACK information and a second PUCCH in the resource using PUCCH format 0 for positive or negative SR. In this case, the first PUCCH is associated with a first panel/TRP/CC/uplink index, and the second PUCCH is associated with a second panel/TRP/CC/uplink index.

### Case 3

In some embodiments, the UE would transmit SR in a resource using PUCCH format 0 and HARQ-ACK information bits in a resource using PUCCH format 1 in a slot.

If the simultaneous uplink transmission scheme is not provided, the UE transmits only a PUCCH with the HARQ-ACK information bits in the resource using PUCCH format 1.

If the simultaneous uplink transmission scheme is provided, the UE transmits a first PUCCH with the HARQ-ACK information bits in the resource using PUCCH format 1 and a second PUCCH with SR in the resourcing using PUCCH format 1. In this case, the first PUCCH is associated with a first panel/TRP/CC/uplink index, and the second PUCCH is associated with a second panel/TRP/CC/uplink index.

### Case 4

In some embodiments, the UE would transmit positive SR in a first resource using PUCCH format 1 and at most two HARQ-ACK information bits in a second resource using PUCCH format 1 in a slot.

If the simultaneous uplink transmission scheme is not provided, the UE transmits a PUCCH with HARQ-ACK information bits in the first resource using PUCCH format 1 only.

If the simultaneous uplink transmission scheme is provided, the UE transmits a first PUCCH with positive SR in a first resource using PUCCH format 1 and a second PUCCH with HARQ-ACK information bits in the second resource using PUCCH format 1. In this case, the first PUCCH is associated with a first panel/TRP/CC/uplink index, and the second PUCCH is associated with a second panel/TRP/CC/uplink index.

### Case 5

If the simultaneous uplink transmission scheme is not provided, the UE does not multiplex different UCI types in a PUCCH transmission with repetitions over multiple slots.

If the simultaneous uplink transmission scheme is provided, the UE multiplexes different UCI types in a PUCCH transmission with repetitions over multiple slots. In this case, the first PUCCH repetition(s) of the first UCI type is associated with a first panel/TRP/CC/uplink index, and the second PUCCH repetition(s) of the second UCI type is associated with a second panel/TRP/CC/uplink index.

### Case 6

The UE would transmit CSI reports on overlapping physical channels.

If the simultaneous uplink transmission scheme is not provided, the UE applies the priority rules for the multiplexing of CSI reports.

If the simultaneous uplink transmission scheme is provided, the UE would transmits a first physical channel and a second physical channel for the CSI reports. In this case, the physical channel can be PUCCH or PUSCH, and the first physical channel is associated with a first panel/TRP/CC/uplink index, the second physical channel is associated with a second panel/TRP/CC/uplink index.

### Implementation 3: Resource Lack of UCI Reporting

### Case 1

In some embodiments, the UE may transmit one or two PUCCHs on a serving cell in different symbols within a slot, and the two PUCCHs may be configured with different priorities. In Case 1, the UE transmits two PUCCHs in a slot and the UE is not provided ackNackFeedbackMode=separate.

If the simultaneous uplink transmission scheme is NOT provided, at least one of the two PUCCHs uses PUCCH format 0 or PUCCH format 2.

If the simultaneous uplink transmission scheme is provided, these two PUCCHs can use any one of PUCCH format 0/1/2/3/4. In this case, the first PUCCH is associated with a first panel/TRP/CC/uplink index, the second PUICCH is associated with a second panel/TRP/CC/uplink index.

### Case 2

In some embodiments, the UE is not provided ackNackFeedbackMode=separate.

If the simultaneous uplink transmission scheme is not provided, at least one of the two PUCCHs uses PUCCH format 0 or PUCCH format 2.

If the simultaneous uplink transmission scheme is provided, these two PUCCHs can use any one of PUCCH format 0/1/2/3/4. In this case, the first PUCCH is associated with a first panel/TRP/CC/uplink index, the second PUICCH is associated with a second panel/TRP/CC/uplink index.

### Case 3

In some embodiments, the UE determines that, for a SR transmission occasion in a PUCCH, the number of symbols available for the PUCCH transmission in a slot is smaller than the value provided by a parameter, nrofSymbols.

If the simultaneous uplink transmission scheme is not provided, the UE does not transmit the PUCCH in the slot.

If the simultaneous uplink transmission scheme is provided, the UE transmits a first PUCCH and a second PUCCH in the slot. In this case, the first PUCCH is associated with a first panel/TRP/CC/uplink index, and the second PUCCH is associated with a second panel/TRP/CC/uplink index. In addition, the number of symbols of the first PUCCH is equal to the number of symbols available for the PUCCH per slot or the half of the value provided by nrofSymbols, and the number of symbols of the second PUCCH is equal to the value provided by nrofSymbols minus the number of symbols of this first PUCCH.

### Case 4

In some embodiments, a UE would report CSI with a total number of UCI bits and CRC bits larger than 115 bits when configured with PUCCH format 4.

If the simultaneous uplink transmission scheme is not provided, the UE does not expect to transmit this CSI report.

If the simultaneous uplink transmission scheme is provided, the UE transmits a first PUCCH/PUSCH with the first part of the CSI report and a second PUCCH/PUSCH with the second part of the CSI report. In this case, the first PUCCH/PUSCH is associated with a first panel/TRP/CC/uplink index, and the second PUCCH/PUSCH is associated with a second panel/TRP/CC/uplink index. In addition, the payload the first part of the CSI report transmitted in the first PUCCH/PUSCH is 115 bits or the half of the total payload of the CSI report, and the payload of the second part of the CSI report transmitted in the first PUCCH/PUSCH is the rest bits.

### Implementation 4: UCI Reporting in PUSCH

### Case 1

In some embodiments, a UE would transmit on a serving cell a PUSCH without UL-SCH that overlaps with a PUCCH transmission on a serving cell that includes positive SR information.

If the simultaneous uplink transmission scheme is not provided, the UE does not transmit the PUSCH.

If the simultaneous uplink transmission scheme is provided, the UE transmits a first PUCCH with positive SR information and a second PUSCH without UL-SCH. In this case, the first PUCCH is associated with a first panel/TRP/CC/uplink index, and the second PUSCH is associated with a second panel/TRP/CC/uplink index.

### Case 2

In some embodiments, the semi-persistent CSI reporting on PUSCH activated by a DCI format is multiplexed with uplink data on a PUSCH.

If the simultaneous uplink transmission scheme is not provided, the UE is not expect to multiplex the semi-persistent CSI reporting.

If the simultaneous uplink transmission scheme is provided, the UE would transmit a first PUSCH with uplink data only and a second PUCCH/PUSCH with the semi-persistent CSI reporting. In this case, the first PUSCH is associated with a first panel/TRP/CC/uplink index, and the second PUCCH/PUSCH is associated with a second panel/TRP/CC/uplink index.

### Case 3

In some embodiments, CSI reporting on PUSCH comprises two parts.

If the simultaneous uplink transmission scheme is not provided, the UE may omit a portion of the Part 2 CSI. When omitting Part 2 CSI information for a particular priority level, the UE shall omit all of the information at that priority level.

If the simultaneous uplink transmission scheme is provided, the UE would transmit a first PUSCH with Part 1 CSI and a second PUSCH with Part 2 CSI. In this case, the first PUSCH is associated with a first panel/TRP/CC/uplink index, the second PUSCH is associated with a second panel/TRP/CC/uplink index.

### Case 4

In some embodiments, the UE is scheduled to transmit a transport block on PUSCH not using repetition type B multiplexed with a CSI report(s), when code rate is larger than a threshold.

If the indication of simultaneous uplink transmission scheme is not provided, the UE may omit Part 2 CSI level by level, beginning with the lowest priority level until the lowest priority level is less than or equal to the threshold.

If the indication of simultaneous uplink transmission scheme is provided, the UE would transmit a first PUSCH, which not using repetition type B, with the transport block only and a second PUSCH or PUCCH multiplexed with the CSI report(s). In this case, the first PUSCH is associated with a first panel/TRP ID, the second PUSCH/PUCCH is associated with a second panel/TRP ID.

### Case 5

In some embodiments, the UE is scheduled to transmit a transport block on PUSCH using repetition type B multiplexed with a CSI report(s), when code rate is larger than a threshold.

If the simultaneous uplink transmission scheme is not provided, the UE may omit Part 2 CSI level by level, beginning with the lowest priority level until the lowest priority level is less than or equal to the threshold.

If the simultaneous uplink transmission scheme is provided, the UE would transmit a first PUSCH, which using repetition type B, with the transport block only and a second PUSCH or PUCCH multiplexed with the CSI report(s). In this case, the first PUSCH is associated with a first panel/TRP/CC/uplink index, the second PUSCH/PUCCH is associated with a second panel/TRP/CC/uplink index.

### Case 6

In some embodiments, the UE is scheduled to transmit a PUSCH with no transport block multiplexed with a CSI report(s), when code rate is larger than a threshold.

If the simultaneous uplink transmission scheme is not provided, the UE may omit Part 2 CSI level by level, beginning with the lowest priority level until the lowest priority level is less than or equal to the threshold.

If the simultaneous uplink transmission scheme is provided, the UE would transmit a first PUSCH, which with no transport block, with the transport block only and a second PUSCH or PUCCH multiplexed with the CSI report(s). In this case, the first PUSCH is associated with a first panel/TRP/CC/uplink index, the second PUSCH/PUCCH is associated with a second panel/TRP/CC/uplink index.

### Implementation 5: Overlapping Between Two PUSCHs Scheduled by Two DCIs

### Case 1

In some embodiments, the UE is configured by higher layer parameter PDCCH-Config that contains two different values of coresetPoolIndex in ControlResourceSet for the active BWP of a serving cell and PDCCHs that schedule two PUSCHs are associated with different ControlResourceSets having different values of coresetPoolIndex. For any two HARQ process IDs in a given scheduled cell, the UE is scheduled to start a first PUSCH transmission starting in symbol j by a PDCCH associated with a value of coresetPoolIndex ending in symbol i, the UE can be scheduled to transmit a PUSCH starting earlier than the end of the first PUSCH by a PDCCH associated with different values of coresetPoolIndex that ends later than symbol i.

If the simultaneous uplink transmission scheme is not provided, the UE is expect to transmit two PUSCH that do not overlap in the time domain.

If the simultaneous uplink transmission scheme is provided, the UE would transmit two PUSCHs that may overlap in time domain. In this case, the first PUSCH is associated with a first values of coresetPoolIndex, the second PUSCH is associated with a second values of coresetPoolIndex.

### Case 2

In some embodiments, the UE is not provided coresetPoolIndex or is provided coresetPoolIndex with a value of 0 for first CORESETs on active DL BWPs of serving cells, and is provided coresetPoolIndex with a value of 1 for second CORESETs on active DL BWPs of the serving cells, and is provided ackNackFeedbackMode=separate.

If the simultaneous uplink transmission scheme is not provided, the UE does not expect a PUCCH or a PUSCH transmission triggered by a detection of a DCI format in a PDCCH received in a CORESET from the first CORESETs to overlap in time with a PUCCH or a PUSCH transmission triggered by a detection of a DCI format in a PDCCH received in a CORESET from the second CORESETs.

If the simultaneous uplink transmission scheme is provided, the UE would transmit a PUCCH or a PUSCH transmission triggered by a detection of a DCI format in a PDCCH received in a CORESET from the first CORESETs to overlap in time with a PUCCH or a PUSCH transmission triggered by a detection of a DCI format in a PDCCH received in a CORESET from the second CORESETs. In this case, the first PUCCH or PUSCH is associated with a first values of coresetPoolIndex, the second PUCCH or PUSCH is associated with a second values of coresetPoolIndex.

### Case 3

In some embodiments, for any two HARQ process IDs in a given scheduled cell, the UE is scheduled to start a first PUSCH transmission starting in symbol j by a PDCCH ending in symbol i.

If the simultaneous uplink transmission scheme is not provided, the UE is not expected to be scheduled to transmit a PUSCH starting earlier than the end of the first PUSCH by a PDCCH that ends later than symbol i.

If the simultaneous uplink transmission scheme is provided, the UE would be scheduled to transmit a second PUSCH starting earlier than the end of the first PUSCH by a PDCCH that ends later than symbol i. In this case, the first PUSCH is associated with a first panel/TRP/CC/uplink index, the second PUSCH is associated with a second panel/TRP/CC/uplink index.

### Case 4

In some embodiments, the UE is scheduled to transmit another PUSCH by DCI format 0_0, 0_1 or 0_2 scrambled by C-RNTI or MCS-C-RNTI for a give HARQ process before the end of the expected transmission of the last PUSCH for that HARQ process if the latter one is scheduled by a DCI with CRC scrambled by C-RNTI, CS-RNTI or MSC-C-RNTI.

If the simultaneous uplink transmission scheme is not provided, the UE is not expected to be scheduled to transmit the former PUSCH.

If the simultaneous uplink transmission scheme is provided, the UE would be scheduled to transmit the former PUSCH and the latter PUSCH. In this case, the former PUSCH is associated with a first panel/TRP/CC/uplink index, the latter PUSCH is associated with a second panel/TRP/CC/uplink index.

### Case 5

In some embodiments, the UE is configured with two uplinks in a serving cell,

If the simultaneous uplink transmission scheme is not provided, PUSCH retransmission for a TB on the serving cell is not expected to be on a different uplink than the uplink used for the PUSCH initial transmission of that TB.

If the simultaneous uplink transmission scheme is provided, PUSCH retransmission for a TB on the serving cell could be on a different uplink than the uplink used for the PUSCH initial transmission of that TB. In this case, the PUSCH initial transmission in one uplink is associated with a first panel/TRP/CC/uplink index, the PUSCH retransmission in another uplink is associated with a second panel/TRP/CC/uplink index.

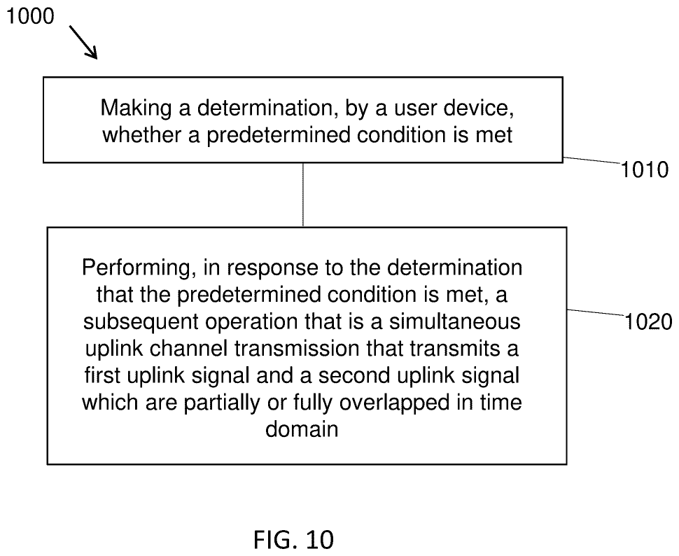

FIG. 10 illustrates a flowchart showing another example method of wireless communication based on some implementations of the disclosed technology. The method 1000 includes, at operation 1010, making a determination, by a user device, whether a predetermined condition is met. The method 1000 further includes, at operation 1020, performing, in response to the determination that the predetermined condition is met, a subsequent operation that is a simultaneous uplink channel transmission that transmits a first uplink signal and a second uplink signal which are partially or fully overlapped in time domain.

In some implementations, the time domain includes a sub-symbol, a symbol, a slot, a sub-frame, a frame, or a transmission occasion. In some implementations, each of the first uplink signal and the second uplink signal is associated with at least one of a first information, a second information, or a third information, the first information identifying at least one of a panel or a TRP (transmission and reception point) of the user device or the network device, the second information identifying at least one of a serving cell or a component carrier (CC), or the third information identifying at least one of a configured or indicated uplink in a serving cell. In some implementations, the first information includes at least one of a panel index or a TRP index, the second information includes at least one of an indicator of a CC, a CC group or a group of CORESETs, or the third information includes at least one of a UL/SUL indicator in the serving cell or the CC, a frequency band index, or a uplink BWP index.

In some implementations, the predetermined condition is met when the user device receives an indication of the simultaneous transmission scheme in a control signalling that is provided by at least one of a radio resource control (RRC), a MAC CE, or a downlink control information (DCI). In some implementations, the predetermined condition is that at least one of: the first information of the first uplink signal is different from the first information of the second uplink signal, the second information of the first uplink signal is different from the second information of the second uplink signal, or the third information of the first uplink signal is different from the third information of the second uplink signal. In some implementations, at least one of the first to third information of the first uplink signal and the first information of the second uplink signal are indicated by at least one of a RRC, a MAC CE, or a DCI. In some implementations, at least one of the first uplink signal or the second uplink signal correspond to a PUCCH, a PUSCH, a SRS, or a PRACH. In some implementations, a TRP index includes at least one of SRS resource set index, spatial relation index, power control parameter set index, TCI state index, CORESET index, CORESETPoolIndex value, physical cell index (PCI), sub-array index, the index of CDM group of DMRS ports, the group index of CSI-RS resources, or CMR set index.

In some implementations, a panel index includes at least one of a user device capability value set index, panel mode index, antenna group index, antenna port group index, beam group index, beam reporting group index, sub-array index, SRS resource set index, spatial relation index, power control parameter set index, CORESETPoolIndex value, or PCI. In some implementations, the first uplink signal carries a uplink control information (UCI) reporting with a priority different from that carried on the second uplink signal or with a type different from that carried on the second uplink signal. In some implementations, the first uplink signal and the second uplink signal have different contents from each other, a content related to at least one of UCI reporting, control data, user data, transmission block, or codeword. In some implementations, the subsequent operation includes, in response to the determination that the predetermined condition is not met, cancelling one of transmissions of the first uplink signal and the second uplink signal. In some implementations, the first uplink signal corresponds to a first PUCCH or a first PUSCH that has a larger priority index scheduled by a DCI format in a first PDCCH reception and the second uplink signal corresponds to a second PUCCH or a second PUSCH that has a smaller priority index than that of the first uplink signal.

In some implementations, (1) the first uplink signal corresponds to a first PUCCH of larger priority index with SR and the second uplink signal corresponds to a second PUCCH or PUSCH of smaller priority index, (2) the first uplink signal corresponds to a first PUCCH of larger priority index with HARQ-ACK information only without a corresponding PDCCH and the second uplink signal corresponds to a second PUCCH of smaller priority index with HARQ-ACK information only, or a second PUCCH of smaller priority index with SR and/or CSI, or a configured grant PUSCH with smaller priority index, or a PUSCH of smaller priority index with a SP-CSI report without the corresponding PDCCH, (3) the first uplink signal corresponds to a PUSCH of larger priority index with SP-CSI reports without the corresponding PDCCH and the second uplink signal corresponds to PUCCH of smaller priority index with SR, or CSI, or HARQ-ACK information only without corresponding PDCCH(s), or (4) the first uplink signal corresponds to a configured grant PUSCH of larger priority index and the second uplink signal corresponds to a configured PUSCH of smaller priority index on a same serving cell.

In some implementations, the first uplink signal corresponds to a first PUCCH of HARQ-ACK information and/or SR with a CSI report that has a higher priority in a resource and the second uplink signal corresponds to a second PUCCH of the CSI report that has the lower priority in another resource. In some implementations, the first uplink signal and the second uplink signal correspond to a first PUCCH and a second PUCCH that overlap in a number of slots, each slot having a UCI type priority satisfying that a UCI report with HARQ-ACK has a higher priority than a UCI report with SR having a priority over a UCI report with CSI with higher priority having a priority over a UCI report with CSI with lower priority. In some implementations, the first uplink signal corresponds to a first PUSCH including a first aperiodic CSI report and the second uplink signal corresponds to a second PUSCH including a SP SCI report or wherein the first uplink signal corresponds to a first PUCCH including a first part of a CSI report and the second uplink signal corresponds to a second PUCCH including a second part of the CSI report. In some implementations, the first uplink signal corresponds to a first PUCCH with HARQ-ACK information or SR (scheduling request) and the second uplink signal corresponds to a second PUCCH with at least one of CSI report, SR, or HARQ-ACK information.

In some implementations, the first uplink signal corresponds to a first PUCCH or PUSCH of a UCI report with a first type or priority and the second uplink signal corresponds to a second PUCCH or PUSCH of a UCI report with a second type or priority. In some implementations, the first uplink signal and the second uplink signal correspond to two PUCCHs with different formats in case that the predetermined condition is not met and the first uplink signal and wherein the second uplink signal have any one of PUCCH formats 0 to 4 in case that the predetermined condition is met. In some implementations, the method further comprises: determining, by the user device, that a number of symbols available for PUCCH transmission in a slot is smaller than a value provided by a higher layer parameter. In some implementations, the method further comprises: reporting, by the user device, CSI with a total number of UCI bits and CRC bits that are greater than 115 bits. In some implementations, the first uplink signal corresponds to a first PUCCH of a positive SR and the second uplink signal corresponds to a second PUSCH without UL-SCH. In some implementations, the first uplink signal corresponds to a first PUSCH with uplink data only and the second uplink transmission signal corresponds to a second PUCCH or PUSCH of a semi-persistent CSI reporting. In some implementations, the first uplink signal corresponds to a first PUSCH of a first part of a CSI reporting and the second uplink signal corresponds to a second PUSCH of a second part of the CSI reporting.

In some implementations, the first uplink signal corresponds to a first PUSCH with TB only and the second uplink transmission signal corresponds to a second PUCCH or PUSCH of a CSI reporting. In some implementations, the first uplink signal and the second uplink signal correspond to a first PUSCH and a second PUSCH, respectively, and wherein the first PUSCH and the second PUSCH are associated with different control resource sets having different values of a CORESET pool index parameter. In some implementations, the first uplink signal and the second uplink signal correspond to a first PUSCH and a second PUSCH, respectively, and wherein the first PUCCH or the first PUSCH is triggered by a detection of a first downlink control information format in a first PDCCH received in a first CORESET from first CORESETs and the second PUCCH or the second PUSCH is triggered by a detection of a second downlink control information format in a second PDCCH received in a second CORESET from second CORESETs. In some implementations, the first uplink signal and the second uplink signal correspond to a first PUSCH and a second PUSCH, respectively, and wherein and wherein a transmission of the first PUSCH starts in symbol j by a PDCCH that ends later than symbol i and the second PUSCH starts earlier than an end of the first PUSCH, i and j being positive integers. In some implementations, the first uplink signal and the second uplink signal correspond to a first PUSCH and a second PUSCH, respectively, and wherein and wherein the second PUSCH is transmitted according to DCI format for a HARQ process before an end of an expected transmission of the first PUSCH for the HARQ process. In some implementations, the first uplink signal corresponds to a first PUSCH of an initial transmission of a TB in a first uplink in a serving cell and the second uplink signal is a second PUSCH of a retransmission of a TB in a second uplink in the serving cell.

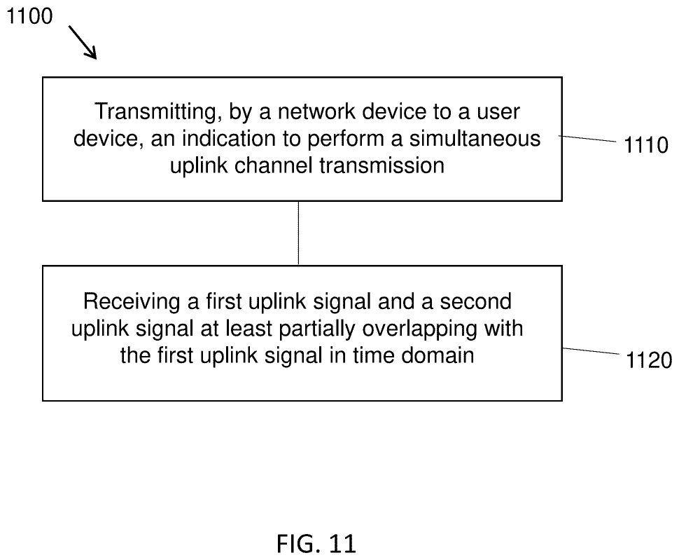

FIG. 11 illustrates a flowchart showing another example method of wireless communication based on some implementations of the disclosed technology. The method 1100 includes, at operation 1110, transmitting, by a network device to a user device, an indication to perform a simultaneous uplink channel transmission. The method 1100 includes, at operation 1120, receiving a first uplink signal and a second uplink signal at least partially overlapping with the first uplink signal in time domain.

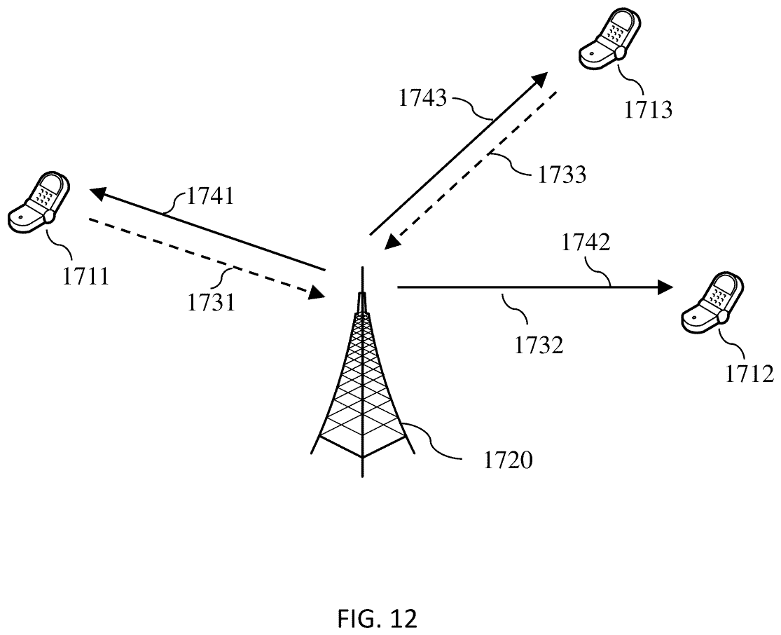

The implementations as discussed above will apply to a wireless communication. FIG. 12 shows an example of a wireless communication system (e.g., a 5G or NR cellular network) that includes a base station 1720 and one or more user equipment (UE) 1711, 1712 and 1713. In some embodiments, the UEs access the BS (e.g., the network) using implementations of the disclosed technology 1731, 1732, 1733, which then enables subsequent communication (1741, 1742, 1743) from the BS to the UEs. The UE may be, for example, a smartphone, a tablet, a mobile computer, a machine to machine (M2M) device, an Internet of Things (IoT) device, and so on.

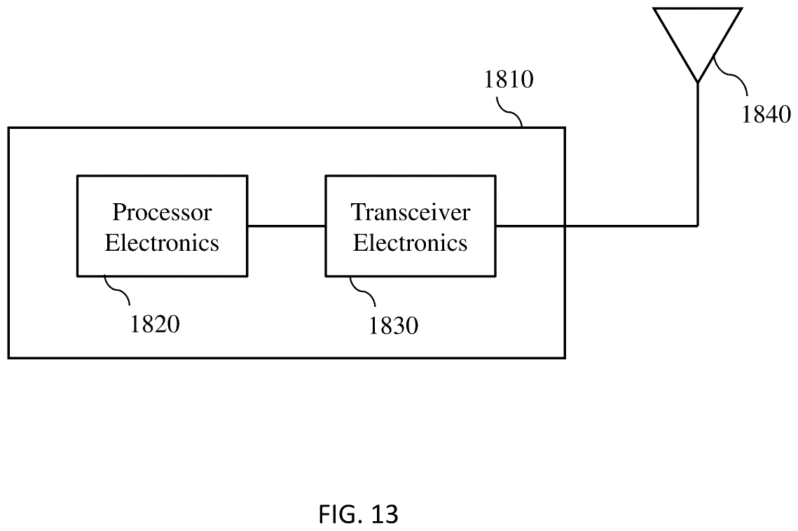

FIG. 13 shows an example of a block diagram representation of a portion of an apparatus. An apparatus 1810 such as a base station or a user device which may be any wireless device (or UE) can include processor electronics 1820 such as a microprocessor that implements one or more of the techniques presented in this document. The apparatus 1810 can include transceiver electronics 1830 to send and/or receive wireless signals over one or more communication interfaces such as antenna 1840. The apparatus 1810 can include other communication interfaces for transmitting and receiving data. The apparatus 1810 can include one or more memories (not explicitly shown) configured to store information such as data and/or instructions. In some implementations, the processor electronics 1820 can include at least a portion of transceiver electronics 1830. In some embodiments, at least some of the disclosed techniques, modules or functions are implemented using the apparatus 1810.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
making a determination, by a user device, whether a predetermined condition is met; and
performing, in response to the determination that the predetermined condition is met, a subsequent operation that is a simultaneous uplink channel transmission that transmits a first uplink signal and a second uplink signal which are partially or fully overlapped in time domain.
